(19) United States
(12) Patent Application Publication
(10) Pub. No.: US 2015/0242338 A1
(43) Pub. Date: Aug. 27, 2015

(54) MEMORY DEVICE AND METHOD ENABLING PERFORMANCE OF SPECIAL OPERATIONS BY APPLICATION OF MEMORY DEVICE

(71) Applicant: JOON-HO LEE, HWASEONG-SI (KR)

(72) Inventor: JOON-HO LEE, HWASEONG-SI (KR)

(21) Appl. No.: 14/628,367

(22) Filed: Feb. 23, 2015

(30) Foreign Application Priority Data
Feb. 24, 2014 (KR) 10-2014-0021422

(51) Int. Cl. G06F 12/14; G06F 12/02

(52) U.S. Cl. CPC G06F 12/1483; G06F 12/0246; G06F 2212/7209

(57) ABSTRACT

A memory device and a method of enabling performance of special operations by an application specific to the memory device are provided. The method includes performing at least one of a first authentication operation and a second authentication operation of the memory device using at least one normal command received from the application according to at least one predefined rule, respectively, the first and second authentication operations indicating whether the memory device includes a plurality of special operations; and receiving from the application a first normal command with a starting logical sector number of a dummy file and a second normal command with a last logical sector number of the dummy file, enabling determination of whether the at least one of the first authentication operation and the second authentication operation of the memory device is successful.

### CROSS-REFERENCE TO RELATED APPLICATIONS

A claim for priority under 35 U.S.C. §119 is made to Korean Patent Application No. 10-2014-0021422 filed Feb. 24, 2014, in the Korean Intellectual Property Office, the entire contents of which are hereby incorporated by reference.

### BACKGROUND

Embodiments of the inventive concept described herein relate to a semiconductor memory, and more particularly, relate to a method of issuing a command to a memory and a method of processing a command to the memory.

A semiconductor memory device is a memory device fabricated using semiconductor material, such as silicon (Si), germanium (Ge), gallium arsenide (GaAs), indium phosphide (InP), and the like. Semiconductor memory devices are classified into volatile memory devices and nonvolatile memory devices.

Volatile memory devices lose contents stored therein when powered off. Volatile memory devices include, for example, random access memory (RAM), static RAM (SRAM), a dynamic RAM (DRAM), a synchronous DRAM (SDRAM). Nonvolatile memory devices retain stored contents even when powered off. Nonvolatile memory devices include, for example, read only memory (ROM), programmable ROM (PROM), electrically programmable ROM (EPROM), electrically erasable and programmable ROM (EEPROM), flash memory, phase-change RAM (PRAM), magnetic RAM (MRAM), resistive RAM (RRAM), and ferroelectric RAM (FRAM).

### SUMMARY

According to aspects of the inventive concept, a method is provided for enabling performance of special operations by an application specific to the memory device is provided. The method includes performing at least one of a first authentication operation and a second authentication operation of the memory device using at least one normal command received from the application according to at least one predefined rule, respectively, the first and second authentication operations indicating whether the memory device includes a plurality of special operations; and receiving from the application a first normal command with a starting logical sector number of a dummy file and a second normal command with a last logical sector number of the dummy file, enabling determination of whether the at least one of the first authentication operation and the second authentication operation of the memory device is successful.

According to other aspects of the inventive concept, a memory device includes a host interface, a nonvolatile memory and a controller. The host interface interfaces communications with a host device running an application. The nonvolatile memory stores multiple special operations executable by the application. The controller accesses the nonvolatile memory in response to normal commands received from the application through the host interface. The controller is configured to perform an authentication operation using a normal command and corresponding address received from the application through the host interface according a predefined rule, the authentication operation indicating whether the nonvolatile memory includes the plurality of special operations; and to receive a first normal command with a starting logical sector number of a dummy file and a second normal command with a last logical sector number of the dummy file, enabling determination of whether the authentication operation is successful.

According to still other aspects of the inventive concept, a method is provided for performing special operations specific to a memory device. The method includes initiating at least one of a first authentication operation and a second authentication operation of the memory device by issuing to the memory device at least one normal command device according to at least one predefined rule, respectively, the first and second authentication operations indicating whether the memory device includes a plurality of special operations; issuing to the memory device a first normal command with a starting logical sector number of a dummy file in the memory device and a second normal command with a last logical sector number of the dummy file; and determining whether the at least one of the first authentication operation and the second authentication operation of the memory device is successful based on responses by the memory device to the first and second normal commands, respectively.

### BRIEF DESCRIPTION OF THE FIGURES

Exemplary embodiments of the inventive concept will be more clearly understood from the following description taken in conjunction with the accompanying drawings, where like reference numerals refer to like parts throughout unless otherwise specified, and in which:

FIG. 1 is a block diagram schematically illustrating a computing device, according to a first embodiment of the inventive concept;

FIG. 2 is a block diagram schematically illustrating a software hierarchy of a computing system accessing a memory or an external memory, according to embodiments of the inventive concept;

FIG. 3 is a block diagram schematically illustrating a computing device, according to a second embodiment of the inventive concept;

FIG. 4 is a block diagram schematically illustrating a memory, according to an embodiment of the inventive concept;

FIG. 5 is a flow chart schematically illustrating a special operation executing method, according to an embodiment of the inventive concept;

FIG. 6 is a flow chart schematically illustrating an authentication step, according to an embodiment of the inventive concept;

FIG. 7 is a diagram schematically illustrating storage areas of a memory, according to embodiments of the inventive concept;

FIG. 8 is a flow chart schematically illustrating an authentication method, according to a first embodiment of the inventive concept;

FIG. 9 is a status diagram schematically illustrating operation of a memory performing the method shown in FIG. 8, according to an embodiment of the inventive concept;

FIG. 10 is a flow chart schematically illustrating an authentication method according to a second embodiment of the inventive concept;

FIG. 11 is a status diagram schematically illustrating operation of a memory performing the method shown in FIG. 10, according to the second embodiment of the inventive concept;

FIG. 12 is a flow chart schematically illustrating an authentication method, according to a third embodiment of the inventive concept;

FIG. 13 is a detailed flow chart showing an operation of a host in authentication and authentication checking steps of FIGS. 8 to 12, according to embodiments of the inventive concept;

FIG. 14 is a detailed flow chart showing an operation of a memory in authentication and authentication checking steps of FIGS. 8 to 12, according to embodiments of the inventive concept;

FIG. 15 is a table showing an authentication operation described with reference to FIGS. 8 to 12, according to embodiments of the inventive concept;

FIG. 16 is a flow chart schematically illustrating an operation of a host when a special operation is issued, according to embodiments of the inventive concept;

FIG. 17 is a flow chart showing an operation of a memory when a special operation is issued, according to embodiments of the inventive concept;

FIG. 18 is a table showing commands and addresses associated with special operations, according to an embodiment of the inventive concept;

FIG. 19 is a table showing commands and addresses allocated to special operations at issuing of a special operation described with reference to FIG. 18, according to an embodiment of the inventive concept;

FIG. 20 is a flow chart schematically illustrating an example in which a special operation is issued, according to embodiments of the inventive concept;

FIG. 21 is a table showing commands and addresses allocated to special operations, according to another embodiment of the inventive concept;

FIG. 22 is a table showing commands and addresses allocated to special operations, according to still another embodiment of the inventive concept;

FIG. 23 is a table showing commands and addresses allocated to special operations, according to a further embodiment of the inventive concept; and

FIG. 24 is a block diagram schematically illustrating a software hierarchy, according to an embodiment of the inventive concept.

### DETAILED DESCRIPTION

Embodiments will be described in detail with reference to the following description and accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to one of ordinary skill in the art. Accordingly, known processes, elements, and techniques are not described with respect to some of the embodiments. Unless otherwise noted, like reference numerals denote like elements throughout the attached drawings and written description, and thus descriptions may not be repeated. In the drawings, sizes and relative sizes of layers and regions may be exaggerated for clarity. Also, the term “exemplary” is intended to refer to an example or illustration.

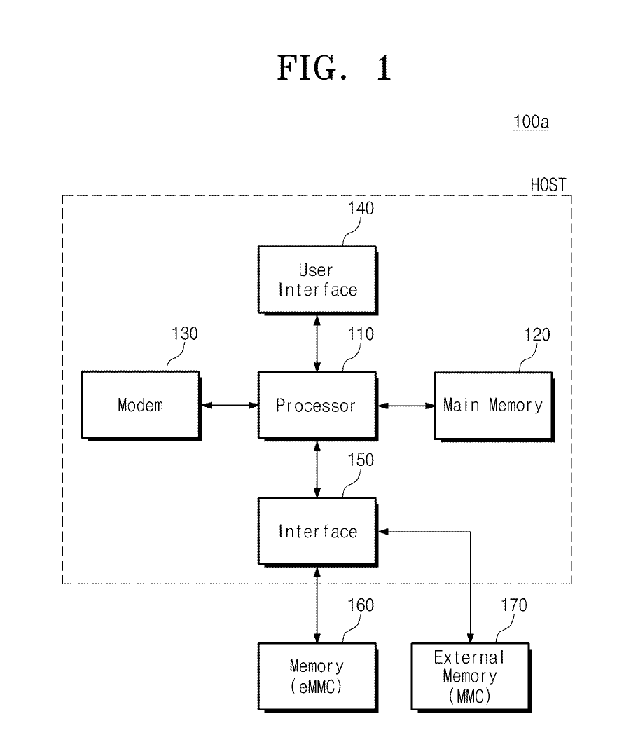

FIG. 1 is a block diagram schematically illustrating a computing device, according to a first embodiment of the inventive concept. Referring to FIG. 1, a computing device 100a includes a processor 110, a main memory 120, a modem 130, a user interface 140, an interface 150, a memory 160, and an external memory 170.

The processor 110 controls overall operation of the computing device 100a to perform logical operations. For example, the processor 110 may be formed of a system-on-chip (SoC). The processor 110 may include a general-purpose processor, a special-purpose processor, and the like.

The main memory 120 is a working memory of the processor 110. The main memory 120 stores data and codes driven by the processor 110. The main memory 120 may include random access memory. For example, the main memory 120 may include a volatile random access memory such as DRAM, SRAM, SDRAM or the like. The main memory 120 may include a nonvolatile random access memory, such as FRAM, PRAM, MRAM, RRAM or the like.

The modem 130 communicates with an external device under control of the processor 110. For example, the modem 130 may communicate with an external device based on at least one of various wireless communication standards, such as Long Term Evolution (LTE), WiMax, Global System for Mobile communication (GSM), Code Division Multiple Access (CDMA), Bluetooth, Near Field Communication (NFC), WiFi, Radio Frequency Identification (RFID), and the like. The modem 130 may be integrated in a semiconductor integrated circuit together with the processor 110.

The user interface 140 communicates with a user under control of the processor 110. For example, the user interface 140 may include user input interfaces, such as a keyboard, a keypad, a button, a touch panel, a touch screen, a touch pad, a touch ball, a camera, a microphone, a gyroscope sensor, a vibration sensor, and the like. The user interface 140 may further include user output interfaces such as an LCD device, an (Organic Light Emitting Diode (OLED) display device, an Active Matrix OLED (AMOLED) display device, an LED, a speaker, a motor, and the like.

The interface 150 interfaces communications between the processor 110 and storage devices, such as the memory 160 and the external memory 170. The memory 160 communicates with the processor 110 through the interface 150, and is accessible by the processor 110. The memory 160 may include a nonvolatile memory and an embedded MultiMedia Card (eMMC), for example. The external memory 170 communicates with the processor 110 through the interface 150, and is accessible by the processor 110. The external memory 170 may be a removable nonvolatile memory, and may include a MultiMedia Card (MMC).

In exemplary embodiments, the computing device 100a is a portable smart multimedia device such as a smart phone, a smart tablet or the like.

The processor 110, main memory 120, modem 130, user interface 140, and interface 150 may constitute a host of the memory 160 and/or the external memory 170.

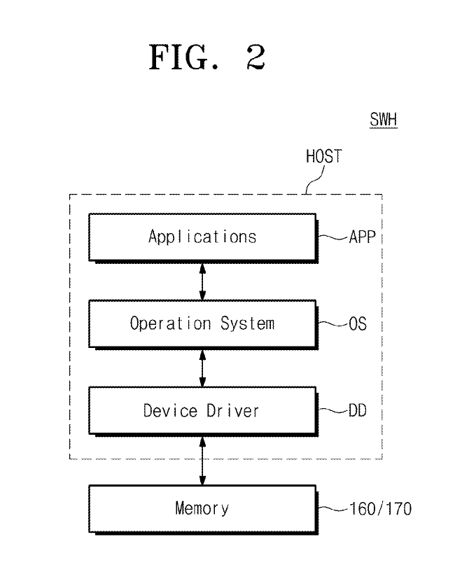

FIG. 2 is a block diagram schematically illustrating software hierarchy SWH of a computing system 100a accessing the memory 160 or the external memory 170. Referring to FIGS. 1 and 2, the software hierarchy SWH contains applications APP, an operating system OS, a device driver DD, and memory 160/170.

The applications APP are driven by a processor 110 on the operating system OS. The applications APP are accessed according to requests of a user (e.g., a user of the computing device 100a) or according to a predetermined schedule, using a resource (e.g., a memory, an operation ability or the like) allocated by the operating system OS. The applications APP may include a variety of software for executing various purposes. The applications APP may include a word processor, a spread sheet, a database, software for generating and playing multimedia contents, for example. The applications APP may also include software for managing the memory 160/170 efficiently.

The operating system OS is driven by the processor 110. The operating system OS manages resources (e.g., memories, operation ability, and the like) of the computing system 100a. The operating system OS also allocates resources (e.g., memories, operation ability, and the like) of the applications APP. The operating system OS accesses hardware of the computing device 100a according to requests by the applications APP.

The device driver DD converts hardware access requests, which the operating system OS generates, into commands that recognized by the hardware. For example, the operating system OS may generate a logical command for managing resources, and the device driver DD converts the logical command, generated by the operating system OS, into a physical command.

The memory 160/170 is accessed by commands transmitted from the device driver DD. The applications APP, operating system OS, and device driver DD may constitute a host of the memory 160/170.

In a typical smart multimedia device, the operating system OS does not grant root authority to the applications APP. That is, the applications APP do not access components of the computing device 100a directly. The applications APP access an OS-distributed resource through the operating system OS using an authority the operating system OS grants.

Even though device-specific special operations or functions are provided to the memory 160 or the external memory 170, under such a condition that root authority is not granted to the applications APP, the applications APP can not use the device-specific special operations or functions because the operating system OS does not grant authority for the device-specific special operations or functions. Rather, the operating system OS just grants authority for normal operations or functions for general devices.

In exemplary embodiments, the memory 160 or the external memory 170 is fabricated according to the Secure Digital (SD) card specification. In addition to normal commands, the SD card specification allows vendor-specific commands. The normal commands may include a read command, a write command, and the like, that are used to issue operations (e.g., a read operation, a write operation, and the like) being generally used. The vendor-specific commands may include commands by which a vendor defines operations. For example, an operation of supporting an easy test of the memory 160 or the external memory 170, and an operation of supporting a debug of the memory 160 or the external memory 170, etc. may be defined as special operations, and the special operations may be executed using the vendor-specific command.

If the special operations of the memory 160 or the external memory 170 are used during a normal operation of the computing device 100a, operation performance of the computing device 100a is improved. For example, the applications APP use the special operations in addition to normal operations, and operation performance of the computing device 100a is improved.

In the event that the operating system OS driven on the computing device 100a does not grant root authority to the applications APP, the applications APP issue normal commands such as a read command, a write command, etc.; they do not issue the vendor-specific command.

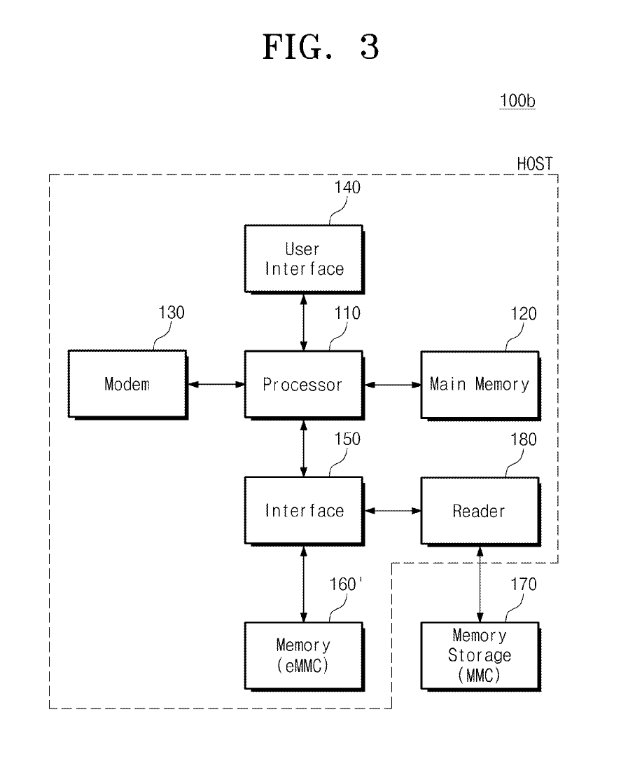

FIG. 3 is a block diagram schematically illustrating a computing device 100b according to a second embodiment of the inventive concept. Referring to FIG. 3, a computing device 100b includes a processor 110, a main memory 120, a modem 130, a user interface 140, an interface 150, a memory 160′, an external memory 170, and a reader 180.

As compared to a computing device 100a shown in FIG. 1, the computing device 100b further comprises the reader 180. The reader 180 communicates with the processor 110 through the interface 150. The reader 180 controls the external memory 170 under control of the processor 110. The memory 160′ of the computing device 100b may include a nonvolatile mass storage device, such as a hard disk drive (HDD), a solid state drive (SSD), or the like. The computing device 100b may be a personal computer, a notebook computer, or the like.

The processor 110, the main memory 120, the modem 130, the user interface 140, the interface 150, the memory 160′, and the reader 180 may constitute a host of the external memory 170.

In exemplary embodiments, a software hierarchy computing device 100b may be the same as that shown in FIG. 2, discussed above. In the event that the computing device 100b is a general-purpose computer, an operating system OS may grant root authority to applications APP. In the event that the computing device 100b is a general-purpose computer, however, the external memory 170, such as an MMC, is connected to the host through the reader 180.

The reader 180 communicates with the interface 150 according to a predefined communication protocol. For example, the reader 180 may communicate with the interface 150 according to a Universal Serial Bus (USB) protocol. The USB protocol supports normal commands (e.g., read and write command), but does not support a function of issuing a vendor-specific command supported by the external memory 170. When the external memory 170 is connected to the interface 150 through the reader 180, the applications APP do not use special operations provided to the external memory 170.

As described with reference to FIG. 1, an operating system OS of a computing device 100a, such as a smart multimedia device, does not grant root authority to applications APP. In this case, although special operations are provided to a memory 160/170, such as MMC or eMMC, the applications APP are unable to issue special commands for executing the special operations. Likewise, as described with reference to FIG. 3, when special operations are provided to a memory (e.g., MMC or eMMC) in a state where the memory 170 is connected to a host through the reader 180 in the computing device 100b, such as a general-purpose computer, the applications APP are unable to issue special commands for executing the special operations.

To address the above-described issues, the computing device 100a or 100b according to an embodiment of the inventive concept may issue a special operation using a normal command and an address. For example, the applications APP driven on the computing device 100a or 100b select a special operation that the memory 160/170 provides. The applications APP select a normal command and an address corresponding to the selected special operation according to a predetermined rule. The applications APP issue the selected normal command and address; therefore, they issue a special operation to the memory 160/170.

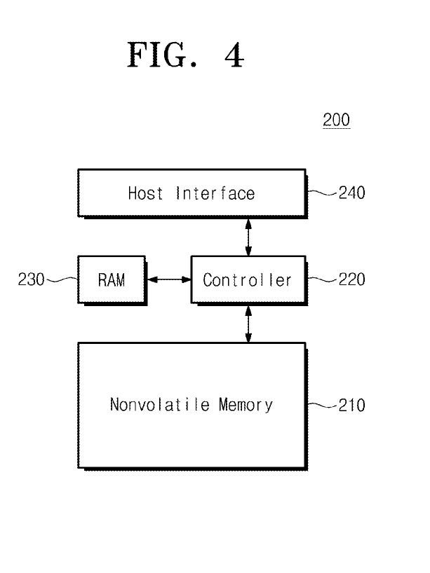

FIG. 4 is a block diagram schematically illustrating a memory 200, which may be a memory 160/170, according to an embodiment of the inventive concept. For example, the memory 200 may be the memory 160, that is, eMMC described with reference to FIGS. 1 to 2. The memory 200 may be the external memory 170, that is, MMC described with reference to FIGS. 1 to 3. Referring to FIG. 4, the memory 200 (or memory 160/170) includes a nonvolatile memory 210, a controller 220, a random access memory 230, and a host interface 240.

The nonvolatile memory 210 may be a flash memory, FRAM, PRAM, MRAM, RRAM, or EEPROM, for example. The controller 220 controls the nonvolatile memory 210, and accesses the nonvolatile memory 210 in response to a command and an address received through the host interface 240. The random access memory 230 may be a working memory of the controller 220. The random access memory 230 may be a buffer memory or a cache memory. The random access memory 230 may be a nonvolatile or volatile random access memory, such as SRAM, DRAM, SDRAM, FRAM, MRAM, or RRAM, for example.

The host interface 240 interfaces communications with a host (not shown). The controller 220 accesses the nonvolatile memory 210 in response to receiving a normal command and an address through host interface 240. The controller 220 performs a special operation in response to the normal command and address received through the host interface 240 according to a predetermined rule.

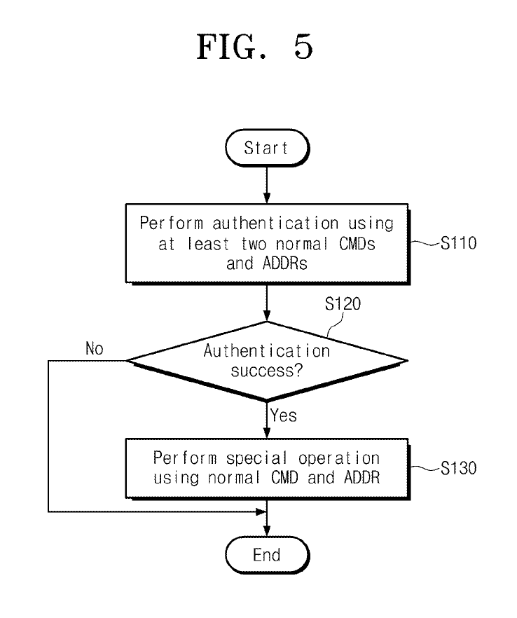

FIG. 5 is a flow chart schematically illustrating a method of executing a special operation, according to an embodiment of the inventive concept. Referring to FIGS. 1 to 3 and 5, in step S110, authentication is made using at least two normal commands and addresses corresponding to the at least two normal commands. For example, a host sequentially transmits at least two normal commands and addresses corresponding to the at least two normal commands to the memory 160/170. The memory 160/170 receives the at least two normal commands and addresses corresponding to the at least two normal commands from the host. The authentication between the memory 160/170 and the host is made based on the at least two normal commands and addresses corresponding to the at least two normal commands.

In step S120, it is determined whether the authentication is successful (passed). When the authentication does not pass, the special operation is not performed. When the authentication has passes, the method proceeds to step S130.

In step S130, the special operation is performed using a normal command and an address. For example, as mentioned above, the host provides the memory 160/170 with at least one normal command and an address corresponding to the at least one normal command. The memory 160/170 receives the at least one normal command and the address corresponding to the at least one normal command from the host. The memory 160/170 performs the special operation based on the at least one normal command and the address corresponding to the at least one normal command.

As described with reference to FIG. 1, when the host does not grant root authority to the memory 160/170, applications APP of the host do not determine whether the memory 160/170 executes the special operation using normal commands and addresses. Likewise, as described with reference to FIG. 3, when the memory 160/170 is connected to the host via the reader 180, the applications APP of the host do not determine whether the memory 160/170 executes the special operation using normal commands and addresses.

Also, the memory 160/170 does not determine whether normal commands and addresses received from the host are associated with an issue of a normal operation. Or, the memory 160/170 does not determine whether normal commands and addresses received from the host are associated with an issue of a special operation.

To address the above-described issues, the host and the memory 160/170 execute an authentication operation (corresponding to step S110). In the event that the authentication operation passes, the host and the memory 160/170 execute a special operation, not being a normal operation, using a normal command and an address. When the authentication operation fails, the host and the memory 160/170 execute a normal operation according to a normal command and an address.

### I. Authentication

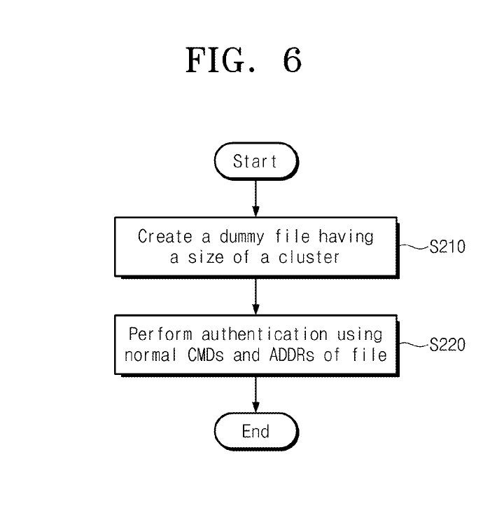

FIG. 6 is a flow chart schematically illustrating step S110, in which authentication is made, according to an embodiment of the inventive concept. Referring to FIGS. 1 to 3 and 6, in step S210, a dummy file is generated with a size corresponding to a cluster. A cluster may be the size of unit data on which an operating system OS accesses the memory 160/170 is based. For example, a cluster may be set to have a 2-sector size, a 4-sector size, or 8-sector size. A cluster size is variable according to a kind of operating system OS or according to a setting of the operating system OS.

In step S220, authentication is made using normal commands and addresses of the dummy file. For example, the dummy file may be a secret file that is generated such that the dummy file is used only by applications wanting to issue a special operation. The dummy file is deleted after the special operation is ended.

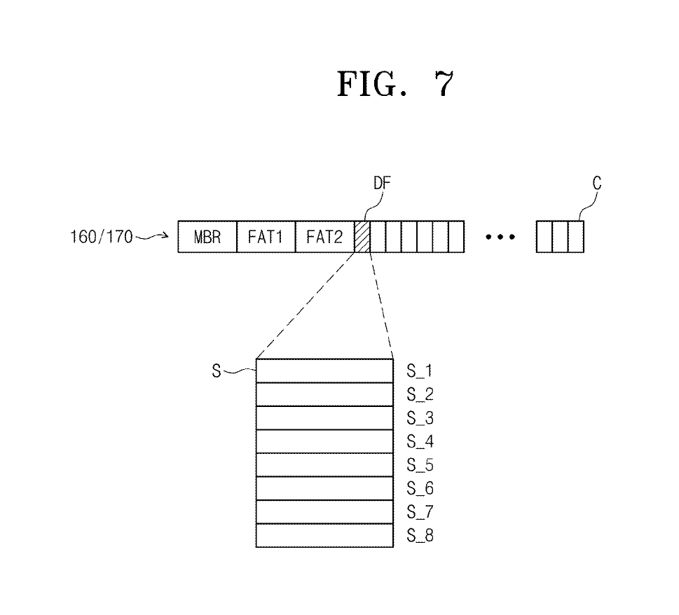

FIG. 7 is a diagram schematically illustrating storage areas of the memory 160/170. The storage areas exemplarily illustrated in FIG. 7 are managed by the operating system OS. Referring to FIGS. 1 to 3, 6, and 7, the memory 160/170 includes a master boot record MBR, file allocation tables FAT1 and FAT2, and clusters C.

The master boot record MBR stores information, such as the number of bytes per sector, the number of sectors per cluster, the number of sectors of a reserved area, the number of FATs, the number of sectors of a FAT, a number of a cluster of a root directory, a boot sector signature, and the like. The FAT1 and FAT2 store file allocation information using a table. The FAT2 is a copy of FAT1. The clusters C store files of data.

The operating system OS manages storage areas of the memory 160/170 by cluster units. When applications APP generate a file, the operating system OS allocates clusters C, the number of which corresponds to a file size, to store the generated file. At this time, clusters allocated by the operating system OS are randomly selected from free clusters from among clusters C of the memory 160/170.

A dummy file DF generated according to an embodiment of the inventive concept, for example, may necessitate the condition that logical addresses are continuous, or at least a portion of the dummy file DF may necessitate the condition that logical addresses are continuous. In the event that the operating system OS randomly selects clusters when a file is generated, continuity of logical addresses has to be secured within one cluster. Thus, the dummy file DF generated according to an embodiment of the inventive concept is generated to have a size corresponding to one cluster.

Each cluster C includes a plurality of sectors, and the cluster allocated to the dummy file DF has the same number of sectors. In FIG. 7, there is shown an example where each cluster C, including the dummy file DF, includes eight sectors S_1 to S_8. However, the number of sectors included in each cluster C may be changed or modified according to a type of operating system OS or according to a setting of the operating system OS.

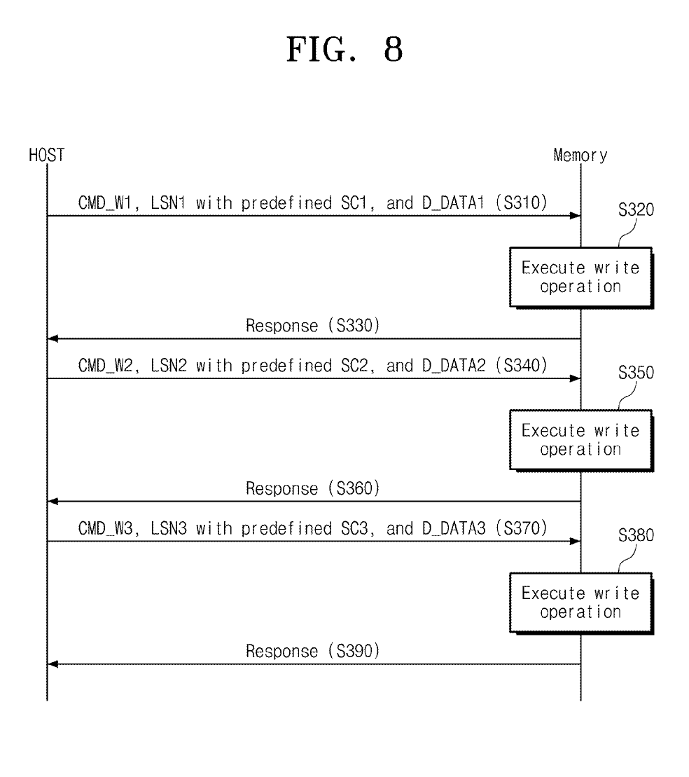

FIG. 8 is a flow chart schematically illustrating an authentication method, according to a first embodiment of the inventive concept. More particularly, FIG. 8 illustrates an embodiment in which authentication is made after a dummy file DF is generated.

Referring to FIGS. 1 to 3 and 8, in step S310, a host (or, application running on the host) provides the memory 160/170 with a first write command CMD_W1, a first logical sector number LSN1 including a first sector count SC1, and first dummy data D_DATA1. For example, a sector count SC may indicate the number of sectors of the memory 160/170 to be written in response to a write command. The sector count SC indicates the number of sectors to be written on the basis of a sector (e.g., from a sector) of the memory 160/170 corresponding to a logical sector number LSN. The host transmits the first sector count SC1 defined according to a predefined rule to the memory 160/170.

Dummy data D_DATA includes a predefined pattern or a predefined arrangement of bits. The dummy data D_DATA includes data used during a previous read operation or write operation (e.g., a normal read or write operation) and is buffered in the host. When wanting to execute authentication, the host provides the memory 160/170 with the first dummy data D_DATA1 for satisfying the communication standard with the memory 160/170. Thus, the format and type of the first dummy data D_DATA1 are not limited.

In step S320, the memory 160/170 executes a write operation in response to the first write command CMD_W1. The memory 160/170 writes the dummy data D_DATA1 at sectors, the number of which corresponds to the first sector count SC1 received in step S310, in response to the first write command CMD_W1 received in step S310.

In step S330, the memory 160/170 sends a response to the host. For example, the response may include a message indicating that the first write command CMD_W1 is normally received or a message indicating that a write operation corresponding to the first write command CMD_W1 is completed.

In step S340, the host provides the memory 160/170 with a second write command CMD_W2, a second logical sector number LSN2 including a second sector count SC2, and second dummy data D_DATA2. For example, the second logical sector number LSN2 transmitted in step S340 may be the same as the first logical sector number LSN1 transferred in step S310. The second sector count SC2 has a value according to a predefined rule. The value of the second sector count SC2 is the same as or different from that of the first sector count SC1.

In step S350, the memory 160/170 executes a write operation in response to the second write command CMD_W2. The memory 160/170 writes the second dummy data D_DATA2 at sectors corresponding to the second logical sector number LSN2 and the second sector count SC2, in response to the second write command CMD_W2 received in step S340. In step S360, the memory 160/170 transmits a response to the host.

In S370, the host provides the memory 160/170 with a third write command CMD_W3, a third logical sector number LSN3 including a third sector count SC3, and third dummy data D_DATA3. For example, the third logical sector number LSN3 may be the same as that of each of the first and second logical sector numbers LSN1 and LSN2. The third sector count SC3 has a value according to a predefined rule. A value of the third sector count SC3 is the same as or different from that of each of the first and second sector counts SC1 and SC2.

In step S380, the memory 160/170 executes a write operation in response to the third write command CMD_W3. The memory 160/170 writes the third dummy data D_DATA3 at sectors corresponding to the third logical sector number LSN3 and the third sector count SC3, in response to the third write command CMD_W3 received in step S370. In step S390, the memory 160/170 transmits a response to the host.

In exemplary embodiments, a logical sector number LSN indicates the number of a sector corresponding to a dummy file DF.

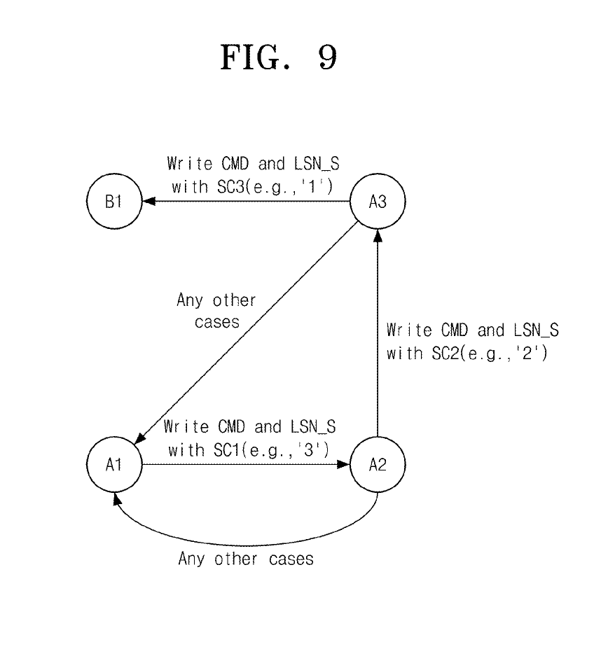

FIG. 9 is a status diagram schematically illustrating operations of the memory 160/170 when the method shown in FIG. 8 is performed. Referring to FIGS. 1 to 3, 8, and 9, the memory 160/170 initially is in an A1 state. In the A1 state, the memory 160/170 recognizes and executes all received commands as normal commands.

When there is a sector count (e.g., SC(3)) received from the host according to a predefined rule together with a write command, the memory 160/170 enters an A2 state. For example, when steps S310 to S330 are performed, the memory 160/170 enters the A2 state.

When in the A2 state, the memory 160/170 checks a next command received. When the next command is a write command regarding the same logical sector number LSN_S and a sector count (e.g., SC(2)) according to a predefined rule is received, the memory 160/170 enters an A3 state. For example, when steps S340 to S360 are performed, the memory 160/170 enters the A3 state. In the event that a command satisfying the above-condition is not received, the memory 160/170 returns to the A1 state.

When in the A3 state, the memory 160/170 checks a next command received. When the next command is a write command regarding the same logical sector number LSN_S and a sector count (e.g., SC(1)) according to a predefined rule is received, the memory 160/170 enters a B1 state. For example, when steps S370 to S390 are performed, the memory 160/170 enters the B1 state. In the event that a command satisfying the above-condition is not received, the memory 160/170 returns to the A1 state.

An operation described with reference to FIGS. 8 and 9 is a first authentication operation. In the event that the host wants to issue a special operation to the memory 160/170, the host first performs the first authentication operation.

In the first authentication operation, the host transmits write commands regarding the same logical sector number LSN using sector counts (e.g., SC(3), SC(2), and SC(1)) with a pattern according to a predefined rule. When write commands are received regarding the same logical sector number LSN using sector counts (e.g., SC(3), SC(2), and SC(1)) with a pattern according to a predefined rule, the memory 160/170 ultimately enters the B1 state. That is, the first authentication operation is passed.

The host performs the first authentication operation under the condition that it does not determine whether the memory 160/170 supports a special operation using a normal command and an address. Data written according to write commands may be dummy data. To prevent data of the memory 160/170 from being lost through rewriting during the first authentication operation, the host executes the first authentication operation using a dummy file DF. The host prevents data of the memory 160/170 from being lost by generating the dummy file DF and issuing a write command regarding the dummy file DF.

For example, the host transmits write commands using a logical sector number LSN of a sector belonging to the dummy file DF. In exemplary embodiments, the host sends write commands using a start logical sector number LSN_S of the dummy file DF. The host transfers a sector count SC which is set so as not to exceed a range of a cluster to which the dummy file DF belongs.

The memory 160/170 performs the first authentication operation in a state where it does not determine whether the host wants to execute the first authentication operation. Commands transmitted from the host may accidently correspond to a pass condition of the first authentication operation. Thus, although commands transmitted from the host correspond to a pass condition of the first authentication operation, the memory 160/170 normally performs the commands transmitted from the host. That is, performing the first authentication operation according to the commands transmitted from the host, the memory 160/170 normally executes the commands transmitted from the host.

FIGS. 8 and 9 provide an example in which the first authentication operation is executed using write commands. However, the inventive concept is not limited thereto. For example, the first authentication operation may be executed using read commands. In this case, a logical sector number is not limited to the number of the sector of the dummy file DF.

The first authentication operation may be performed using a combination of at least one read command and at least one write command. A write command used for the first authentication operation uses a logical sector number of the dummy file DF. A read command used for the first authentication operation is not limited to using a logical sector number of the dummy file DF.

In the example, the first authentication operation uses sector counts according to a predefined rule and a logical sector number. However, the first authentication operation is not limited to the above-described rules. For example, in the first authentication operation, logical sector numbers according to a predefined rule are used with respect to the same sector count. In the first authentication operation, logical sector numbers according to a predefined rule (e.g., a first rule) and sector counts according to a predefined rule (e.g., a second rule) are used. In the first authentication operation, a pattern of commands (e.g., a pattern of at least one read command and at least one write command) according to a predefined rule is also used.

Further, in the example of the first authentication operation, authentication is made using three commands. However, embodiments of the inventive concept are not limited thereto. For example, the first authentication operation may be executed using two commands or four or more commands.

The example of the first authentication operation also describes performing authentication using commands that are continuous. However, embodiments of the inventive concept are not limited thereto. For example, the first authentication operation may be executed using commands with intervals according to a predefined rule.

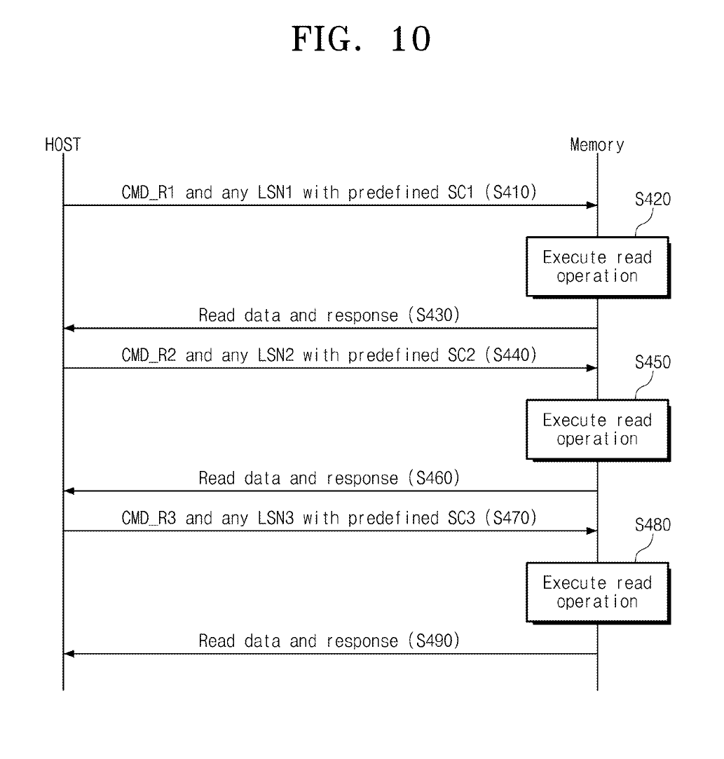

FIG. 10 is a flow chart schematically illustrating an authentication method, according to a second embodiment of the inventive concept. More particularly, FIG. 10 illustrates an embodiment in which a second authentication operation follows a first authentication operation described with reference to FIGS. 8 and 9.

Referring to FIGS. 1 to 3 and 10, in step S410, a host provides the memory 160/170 with a first read command CMD_R1 and a first logical sector number LSN1 including a first sector count SC1 having a value according to a predefined rule. The first logical sector number LSN1 is not limited to a logical sector number of a dummy file DF. The first logical sector number LSN1 is any number.

In step S420, the memory 160/170 performs a read operation in response to the first read command CMD_R1. In step S430, the memory 160/170 sends a response and read data to the host. The response includes a message indicating that the first read command CMD_R1 is normally received or a message indicating that a read operation corresponding to the first read command CMD_R1 is completed.

In step S440, the host provides the memory 160/170 with a second read command CMD_R2 and a second logical sector number LSN2 including a second sector count SC2 having a value according to a predefined rule. The second logical sector number LSN2 is not limited to a logical sector number of a dummy file DF. The second logical sector number LSN2 is any number. In step S450, the memory 160/170 performs a read operation in response to the second read command CMD_R2. In step S460, the memory 160/170 sends a response and read data to the host.

In S470, the host provides the memory 160/170 with a third read command CMD_R3 and a third logical sector number LSN3 including a third sector count SC3 having a value according to a predefined rule. The third logical sector number LSN3 is not limited to a logical sector number of a dummy file DF. The third logical sector number LSN3 is any number. In step S480, the memory 160/170 performs a read operation in response to the third read command CMD_R3. In step S490, the memory 160/170 sends a response and read data to the host.

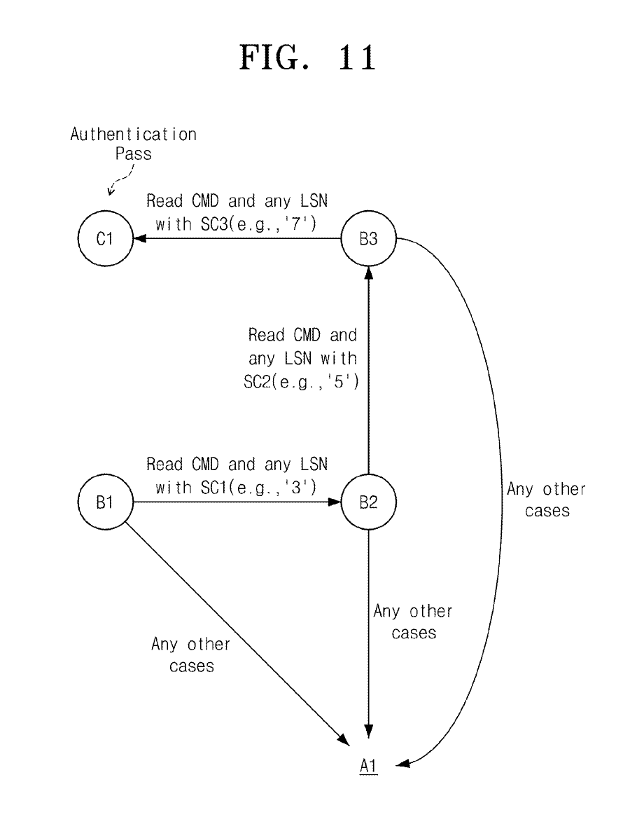

FIG. 11 is a status diagram schematically illustrating operations of the memory 160/170 when the method shown in FIG. 10 is performed. Referring to FIGS. 1 to 3, 10, and 11, the memory 160/170 initially is in a B1 state.

When in the B1 state, the memory 160/170 checks a next command received. When the next command is received together with a sector count (e.g., SC (3)) according to a predefined rule, the memory 160/170 enters a B2 state. For example, when steps S410 to S430 are performed, the memory 160/170 enters the B2 state. The memory 160/170 enters the B2 state according to the sector count SC regardless of a logical sector number LSN. In the event that a command satisfying the above-condition is not received, the memory 160/170 returns to an A1 state (refer to FIG. 9).

When in the B2 state, the memory 160/170 checks a next command received. When the next command is received together with a sector count (e.g., SC(5)) according to a predefined rule, the memory 160/170 enters a B3 state. For example, when steps S440 to S460 are performed, the memory 160/170 enters the B3 state. The memory 160/170 enters the B3 state according to the sector count SC regardless of a logical sector number LSN. In the event that a command satisfying the above-condition is not received, the memory 160/170 returns to the A1 state.

When in the B3 state, the memory 160/170 checks a next command received. When the next command is received together with a sector count (e.g., SC(7)) according to a predefined rule, the memory 160/170 enters a C1 state. For example, when steps S470 to S490 are performed, the memory 160/170 enters the C1 state. The memory 160/170 enters the C1 state according to a sector count SC regardless of a logical sector number LSN. In the event that a command satisfying the above-condition is not received, the memory 160/170 returns to the A1 state.

In the second authentication operation, the host transmits read commands regarding any logical sector number LSN using sector counts (e.g., SC(3), SC(5), and SC(7)) with a pattern according to a predefined rule. When read commands are received regarding any same logical sector number LSN using sector counts (e.g., SC(3), SC(5), and SC(7)) with a pattern according to a predefined rule, the memory 160/170 enters the C1 state. That is, the second authentication operation is passed.

The memory 160/170 performs the second authentication operation under the condition that it does not determine whether the host wants to perform a special operation. Commands transmitted from the host may accidently correspond to a pass condition of the second authentication operation. Thus, although commands transmitted from the host correspond to a pass condition of the second authentication operation, the memory 160/170 normally performs the commands transmitted from the host. That is, performing the second authentication operation according to the commands transmitted from the host, the memory 160/170 normally executes the commands transmitted from the host.

FIGS. 10 and 11 provide an example in which the second authentication operation is executed using read commands. However, the inventive concept is not limited thereto. For example, the second authentication operation may be executed using write commands. In this case, a logical sector number LSN is the number of one of sectors of the dummy file DF.

The second authentication operation is performed using a combination of at least one read command and at least one write command. A write command used for the second authentication operation uses a logical sector number of the dummy file DF. A read command used for the second authentication operation is not limited to use a logical sector number of the dummy file DF.

In the example, the second authentication operation uses sector counts according to a predefined rule and any logical sector numbers. However, the second authentication operation is not limited to the above-described rules. For example, in the second authentication operation, any logical sector numbers and the same sector count, the same logical sector number and any sector counts, the logical sector number and the same sector count, the same logical sector number and sector counts according to a predefined rule, logical sector numbers according to a predefined rule and any sector counts, logical sector numbers according to a predefined rule and the same sector count, or logical sector numbers according to a predefined rule (e.g., a first rule) and sector counts according to a predefined rule (e.g., a second rule) may be used.

In the second authentication operation, a pattern (e.g., a pattern of at least one read command and at least one write command) of commands according to a predefined rule may also be used.

Also, in the example of the second authentication operation, authentication is made using three commands. However, embodiments of the inventive concept are not limited thereto. For example, the second authentication operation may be executed using two commands or four or more commands.

The example of the second authentication operation also describes performing authentication using commands that are continuous. However, embodiments of the inventive concept are not limited thereto. For example, the second authentication operation may be executed using commands with intervals according to a predefined rule.

The second authentication operation described with reference to FIGS. 10 and 11 follows the first authentication operation described with reference to FIGS. 8 and 9. However, the first authentication operation and the second authentication operation may be implemented according to separate embodiments, respectively. Or, the first authentication operation and the second authentication operation may be combined to form one embodiment.

According to an embodiment of the inventive concept, authentication is made based on at least one of a pattern of two or more normal commands (e.g., a sequential pattern of at least one read command and at least one write command), a pattern of two or more logical sector numbers corresponding to two or more normal commands (e.g., the same logical sector numbers, logical sector numbers according to a predefined rule, any logical sector numbers, and the like), and two or more sector counts corresponding to two or more normal commands (e.g., the same sector counts, sector counts according to a predefined rule, any sector counts, and the like). When authentication is made using a write command, a sector number LSN and a sector count SC are limited to a cluster of a dummy file DF. It is understood that the authentication methods shown in FIGS. 8 to 11 are exemplary, and that embodiments other than those shown in FIGS. 8 to 11 may be incorporated without departing from the scope of the present teachings.

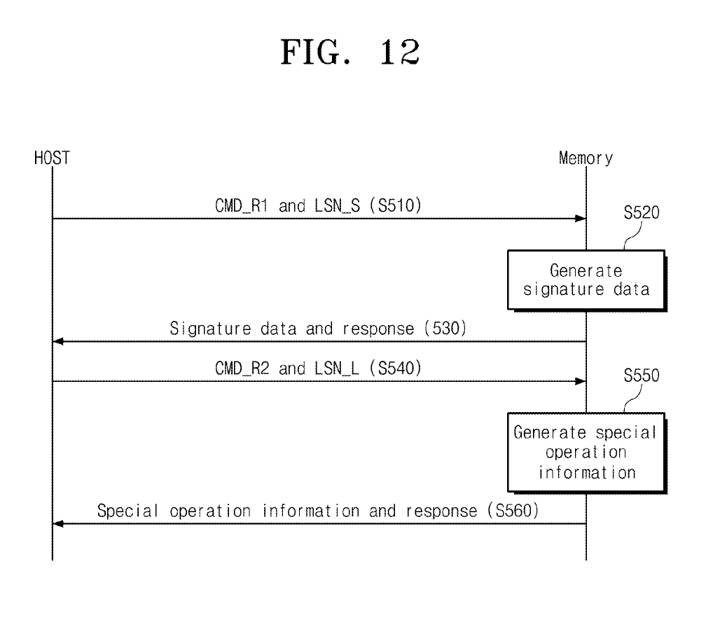

FIG. 12 is a flow chart schematically illustrating an authentication method according to a third embodiment of the inventive concept. In FIG. 12, there is illustrated an authentication checking operation for checking whether authentication is successful, after authentication operations, examples of which are described with reference to FIGS. 8 and 9 or FIGS. 10 and 11.

Referring to FIGS. 1 to 3 and 12, in step S510, a host provides the memory 160/170 with a first read command CMD_R1 and a start logical sector number LSN_S. The start logical sector number LSN_S indicates the number of a sector of a dummy file DF. The first read command CMD_R1 is transmitted together with any sector count.

In step S520, the memory 160/170 generates signature data in response to the first read command CMD_R1. For example, the signature data is data that is previously stored in the memory 160/170. The memory 160/170 generates the signature data by reading the previously stored signature data. The signature data may be data that the memory 160/170 generates, and may be data with a predefined signature data pattern. The signature data is data different from data stored in sectors corresponding to a logical sector address LSN_S and a sector count received from the host. For example, the memory 160/170 stores the start logical sector number LSN_S. In step S530, the memory 160/170 sends the signature data and a response to the host.

In step S540, the host provides the memory 160/170 with a second read command CMD_R2 and the last logical sector number LSN_L. The last logical sector number LSN_L indicates the number of the last sector of the dummy file DF. The second read command CMD_R2 is transmitted together with any sector count.

In step S550, the memory 160/170 generates special operation information in response to the second read command CMD_R2. For example, the special operation information is data that is previously stored in the memory 160/170. The memory 160/170 generates the special operation information by reading the special operation information previously stored. The special operation information may include information about special operations that the memory 160/170 performs, and about methods of issuing special operations to be provided to the memory 160/170. The special operation information is data different from data stored in sectors corresponding to a logical sector address LSN_L and a sector count received from the host in step S530. At that time, for example, the memory 160/170 stores the start logical sector number LSN_L received from the host for later use.

In step S560, the memory 160/170 sends the special operation information and a response to the host.

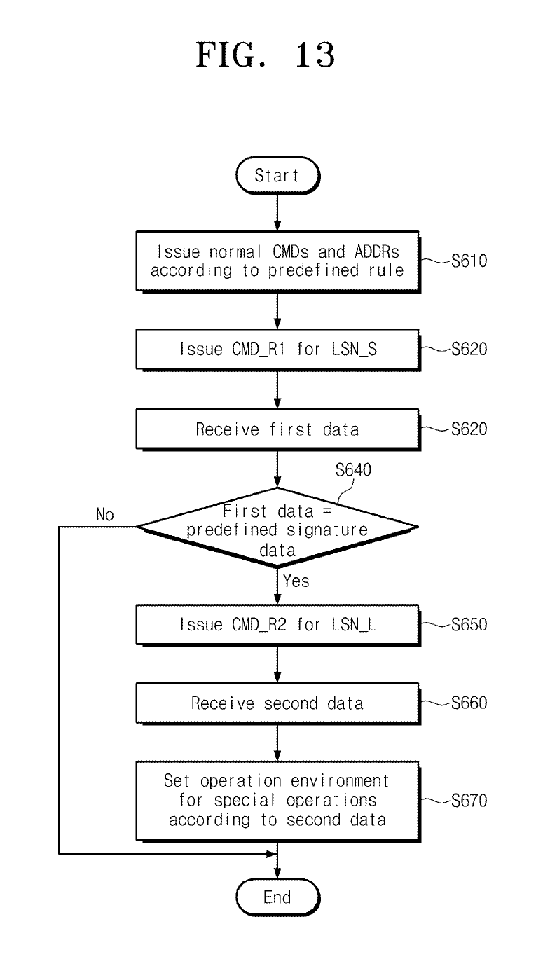

FIG. 13 is a detailed flow chart showing an operation of a host performing authentication and authentication checking steps of FIGS. 8 to 12. Referring to FIGS. 1 to 3 and 13, in step S610, the host issues normal commands and addresses (e.g., logical sector numbers and sector counts) to the memory 160/170 according to a predefined rule. For example, the host issues normal commands and addresses (e.g., a logical sector number and sector counts according to a first rule) to the memory 160/170 according to a first authentication operation described with reference to FIGS. 8 and 9. Or, the host issues normal commands (e.g., read commands) and addresses (e.g., any logical sector numbers and sector counts according to a second rule) to the memory 160/170 according to a second authentication operation described with reference to FIGS. 10 and 11. Or, the host issues normal commands and addresses according to the first and second authentication operations.

In step S620, the host issues a first read command CMD_R1 and a start logical sector number LSN_S of a dummy file DF to the memory 160/170. In step S630, the host receives first data corresponding to the first read command CMD_R1. For example, the first data may be signature data described with reference to FIG. 12.

In step S640, the host determines whether the first data corresponds to predefined signature data. When the first data does not correspond to (e.g., is not equal to) the predefined signature data, it is determined that the memory 160/170 does not support a special operation using a normal command. Thus, the host stops the operation of issuing the special operation. When the first data corresponds to (e.g., is equal to) the predefined signature data, it is determined that the memory 160/170 supports a special operation using a normal command. Thus, the method proceeds to step S650.

In step S650, the host issues a second read command CMD_R2 and the last logical sector number LSN_L of the dummy file DF to the memory 160/170. In step S660, the host receives second data corresponding to the second read command CMD_R2.

In step S670, the host sets up an operation environment for special operations based on the second data. For example, the second data may be special operation information described with reference to FIG. 12. The host sets up an operation environment for special operations based on the special operation information received from the memory 160/170.

As described above, the host determines whether the memory 160/170 supports a special operation using a normal command and an address, by checking signature data read from the memory 160/170. When authentication is successful, the host issues the special operation to the memory 160/170 using a normal command and an address.

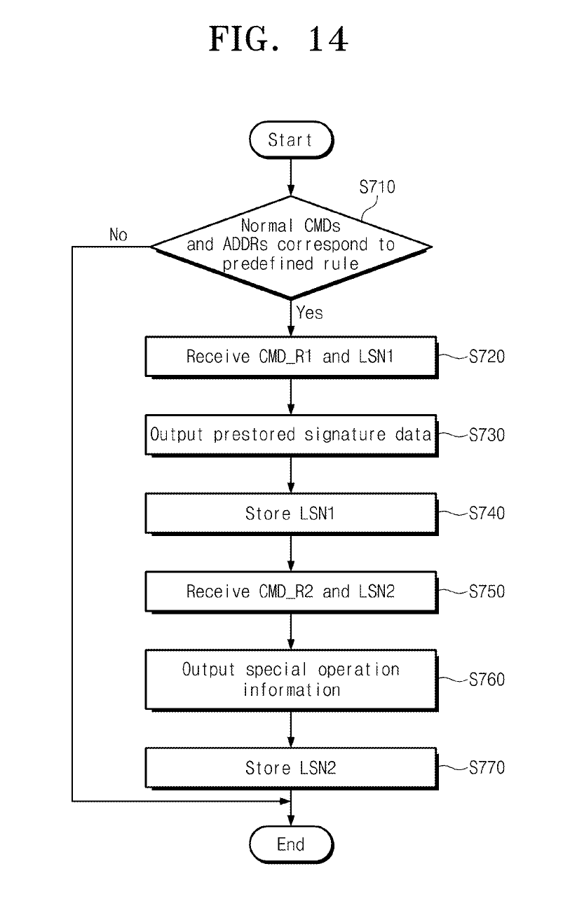

FIG. 14 is a detailed flow chart showing an operation of the memory 160/170 performing authentication and authentication checking steps of FIGS. 8 to 12. Referring to FIGS. 1 to 3 and 14, in step S710, the memory 160/170 determines whether received normal commands and addresses correspond to a predefined rule. For example, the memory 160/170 may determine whether normal commands (e.g., write commands) and addresses (e.g., the same logical sector numbers and sector counts according to a first rule) are received according to a first authentication operation described with reference to FIGS. 8 and 9. Or, the memory 160/170 determines whether normal commands (e.g., read commands) and addresses (e.g., any logical sector numbers and sector counts according to a second rule) are received according to a second authentication operation described with reference to FIGS. 10 and 11. Or, the memory 160/170 determines whether normal commands and addresses are received according to the first and second authentication operations.

When normal commands and addresses do not satisfy a predefined rule, an operation of issuing a special operation is not to be performed, and the memory 160/170 stops authentication. When normal commands and addresses do satisfy a predefined rule, authentication is determined to be passed, and the method proceeds to step S720.

In step S720, the memory 160/170 receives a first read command CMD_R1 and a first logical sector number LSN1. The memory 160/170 may receive any sector count. The first logical sector number LSN1 is the number of a start sector of a dummy file DF.

In step S730, the memory 160/170 outputs previously stored signature data in response to the first read command CMD_R1. In step S740, the memory 160/170 stores the first logical sector number LSN1. In step S750, the memory 160/170 receives a second read command CMD_R2 and a second logical sector number LSN2. The memory 160/170 may receive any sector count. The second logical sector number LSN2 is the number of the last sector of the dummy file DF. In step S760, the memory 160/170 outputs special operation information. In step S770, the memory 160/170 receives a second logical sector number LSN2.

As described above, after authentication is passed, the memory 160/170 stores first and second logical sector numbers LSN1 and LSN2 received together with a read command from the host. Afterwards, a command received together with a sector number between the first and second logical sector numbers is recognized as a normal command and an address associated with a special operation. A command received together with a sector number that is not between the first and second logical sector numbers is recognized as a normal command and an address associated with a normal operation.

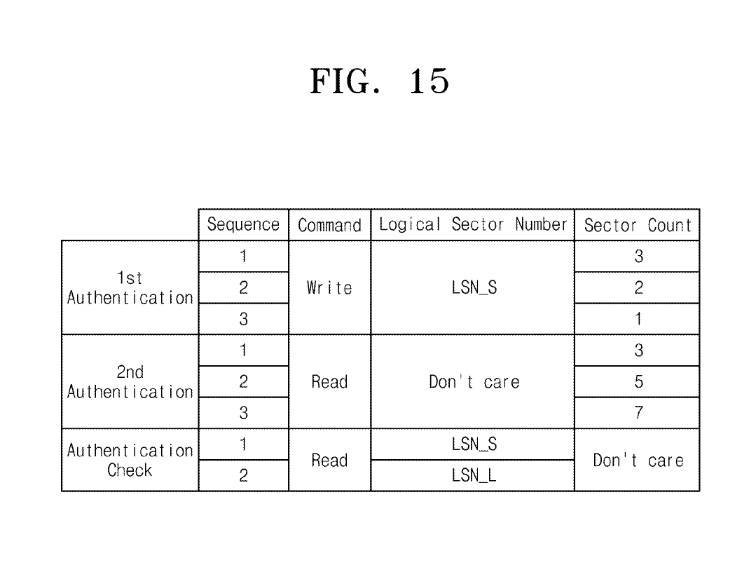

FIG. 15 is a table showing an authentication operation described with reference to FIGS. 8 to 12. Referring to FIG. 15, a first authentication operation is executed using three write commands. The three write commands are issued together with the same logical sector numbers. The same logical sector numbers may be a start logical sector number LSN_S of a dummy file DF. The three write commands are issued together with sector counts according to a predefined rule. For example, the three write commands may be issued together with sector counts indicating “SC3”, “SC2”, and “SC1”.

A second authentication operation is executed using three read commands. The three read commands are issued together with any logical sector numbers. The three read commands are issued together with sector counts according to a predefined rule. For example, the three read commands may be issued together with sector counts indicating “SC3”, “SC5”, and “SC7”.

Authentication is checked using two read commands. The two read commands are issued together with any sector counts. A first read command CMD_R1 is issued together with a start logical sector number LSN_S of a dummy file DF. A second read command CMD_R2 is issued together with the last logical sector number LSN_L of the dummy file DF.

### II. Issuing Special Operation

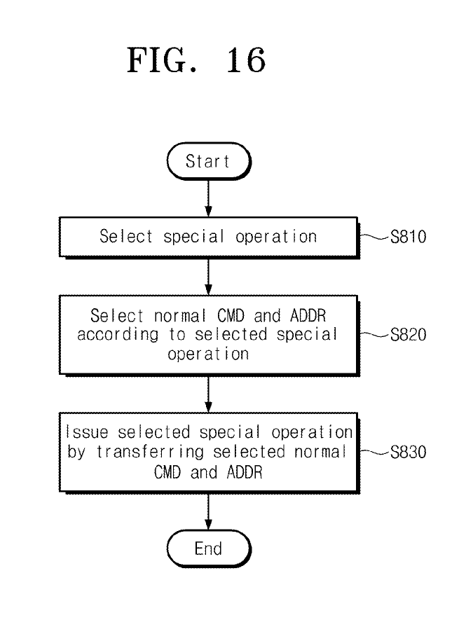

FIG. 16 is a flow chart schematically illustrating an operation of a host (or, application running on the host) when a special operation is issued. Referring to FIGS. 1 to 3 and 16, a special operation is selected in step S810. For example, a host previously stores information about a variety of special operations to be provided to the memory 160/170. The host then selects a special operation based on the previously stored information. For example, the host stores information regarding a variety of special operations to be provided to a variety of memories. The host detects an identifier of the memory 160/170 and decides special operation(s) to be provided to the memory 160/170 according to the detected identifier. The host selects a special operation based on the provided special operations. For example, the host may receive and store information about special operations to be provided to the memory 160/170 from the memory 160/170. Also, for example, as shown in step S560 of FIG. 12, the host receives and stores information about special operations from the memory 160/170. The host selects a special operation based on stored information.

Information about the special operations includes information about types of special operations, as well as a normal command and an address allocated to each special operation. Information about the normal command indicates whether one of a read command and a write command is allocated to each special operation. Information about the address includes a sector offset and a sector count. The sector offset indicates a sector of a dummy file DF corresponding to a logical sector number LSN transmitted together with a command.

In step S820, the host selects a normal command and an address according to the special operation selected. For example, the host detects a normal command and an address (e.g., a logical sector number and a sector count) allocated to the selected special operation from information about special operations to be provided to the memory 160/170. The host selects the detected normal command and address. In step S830, the host issues the special operation selected, by transmitting the selected normal command and address to the memory 160/170.

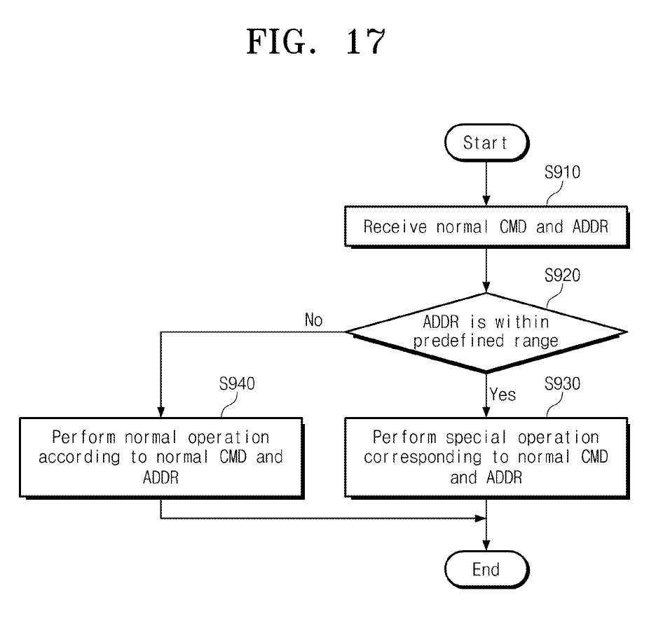

FIG. 17 is a flow chart showing an operation of the memory 160/170 when a special operation is issued. Referring to FIGS. 1 to 3 and 17, in step S910, the memory 160/170 receives a normal command (e.g., a read or write command) and an address (e.g., a logical sector number and a sector counter).

In step S920, the memory 160/170 determines whether a received address is in a predefined range. For example, the memory 160/170 determines whether a logical sector number received is between first and second logical sector numbers LSN1 and LSN2 stored in steps S740 and S770 of FIG. 14.

When the logical sector number received is between the first and second logical sector numbers LSN1 and LSN2, in step S930, the memory 160/170 performs a special operation corresponding to the input normal command and address. When the logical sector number received is not between the first and second logical sector numbers LSN1 and LSN2, in step S940, the memory 160/170 performs a normal operation according to the input normal command and address. For example, the memory 160/170 performs a read operation or a write operation according to an input read command or an input write command, respectively.

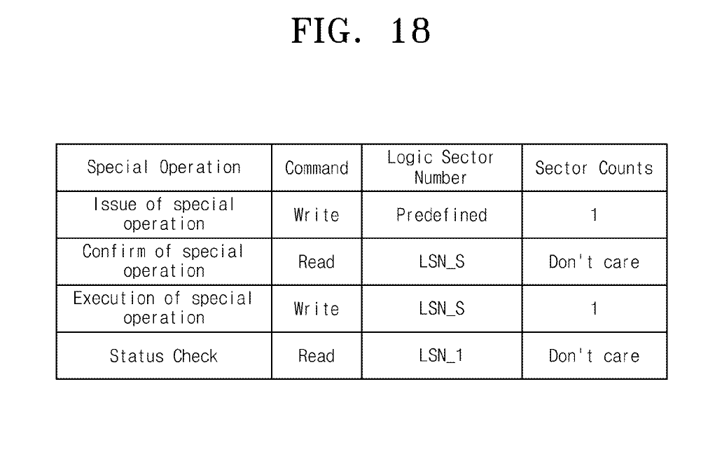

FIG. 18 is a table showing commands and addresses associated with special operations, according to an embodiment of the inventive concept. In FIG. 18, there are shown commands and addresses for issuing exemplary special operations.

Referring to FIG. 18, issuing a special operation is performed using a write command, and using a logical sector number LSN allocated to each special operation. A sector count when a special operation is issued is “1”. Issuing a special operation includes informing the memory 160/170 of the type of special operation to be executed by the host.

The special operation is confirmed using a read command, and using a start logical sector number LSN_S. The start logical sector number LSN_S is the number of a start sector of sectors between first and second logical sector numbers LSN1 and LSN2 described with reference to FIG. 16. The start logical sector number LSN_S is the number of a start sector of a dummy file DF. The special operation is confirmed regardless of a sector count. Confirming the special operation includes checking whether the memory 160/170 normally recognizes the selected special operation, via issuing the special operation.

The special operation is executed using a write command. The special operation is executed using a start logical sector number LSN_S. When the special operation is executed, the sector count is “1”. To execute the special operation includes directing execution of the special operation checked through confirming the special operation.

Status check is performed using a read command. The status check is executed using the first logical sector number LSN_1. The first logical sector number LSN_1 is the number of a next sector of the start sector. The status check is performed regardless of a sector count.

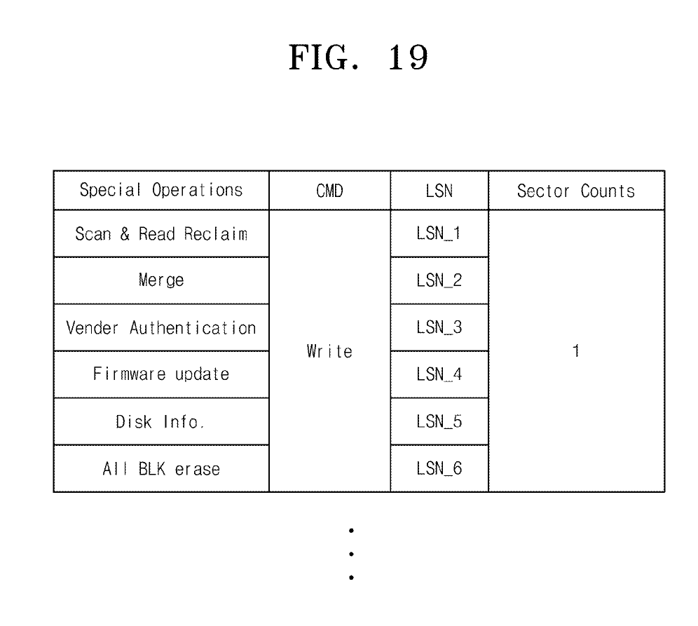

FIG. 19 is a table showing commands and addresses allocated to exemplary special operations upon issuing of a special operation described with reference to FIG. 18, according to an embodiment of the inventive concept. Referring to FIGS. 1 to 3 and 19, the special operations include scan and reclaim, merge, vendor authentication, firmware update, disk information, and all block erase. Other special operations may be included, without departing from the scope of the present teachings.

The scan and read reclaim operation includes scanning all memory blocks of the memory 160/170 and executing read reclaim for memory blocks, necessitating the read reclaim, from among all memory blocks. For example, the scan and read reclaim operation is provided when the memory 160/170 includes a flash memory. The read reclaim operation includes checking the degree of deterioration of data stored in a memory block, reading data having a deterioration level over a reference value, and writing the read data in another memory block. A write command, a first logical sector number LSN_1 of the dummy file DF, and a sector count of “1” are allocated to the scan and read reclaim operation. That is, in the event that the host issues the scan and read reclaim operation to the memory 160/170, it transmits the first logical sector number LSN_1 and the sector count of “1” to the memory 160/170 together with the write command after execution of authentication described above with reference to FIGS. 8 to 12.

The merge operation includes generating free memory blocks of the memory 160/170. For example, the merge operation is provided when the memory 160/170 includes a flash memory. The merge operation includes reading valid data from first memory blocks, storing valid and invalid data from among memory blocks, storing the valid data thus read in a free block, and erasing the first memory blocks to generate a free memory block. A first logical sector number LSN_1 and a sector count of “1” are allocated to the merge operation.

The vendor authentication operation includes requesting authentication of a vendor. For example, the vendor authentication operation includes requesting predefined vendor signature data. A write command, a third logical sector number LSN_3, and a sector count of “1” are allocated to the vendor authentication operation.

The firmware update operation includes requesting an update of firmware. A write command, a fourth logical sector number LSN_4, and a sector count of “1” are allocated to the firmware update operation.

The disk information operation includes requesting fundamental information such as capacity, speed, class, etc., of the memory 160/170. A write command, a fifth logical sector number LSN_5, and a sector count of “1” are allocated to the disk information operation.

The all block erase operation includes requesting erasure of all memory blocks of the memory 160/170. A write command, a sixth logical sector number LSN_6, and a sector count of “1” are allocated to the all block erase operation.

As described above, special operations are distinguished by setting logical sector numbers within a range of numbers of sectors of a cluster to which a dummy file DF belongs. For example, special operations are stored in the memory 160/170. The host reads and uses information about the special operations as special operation information of step S560 (refer to FIG. 12) from the memory 160/170. For example, the host previously stores information about a variety of special operations of various types of memories. The host detects an identifier from the memory 160/170 and selectively acquires information about special operations of the memory 160/170 from information about various special operations previously stored according to the detected identifier.

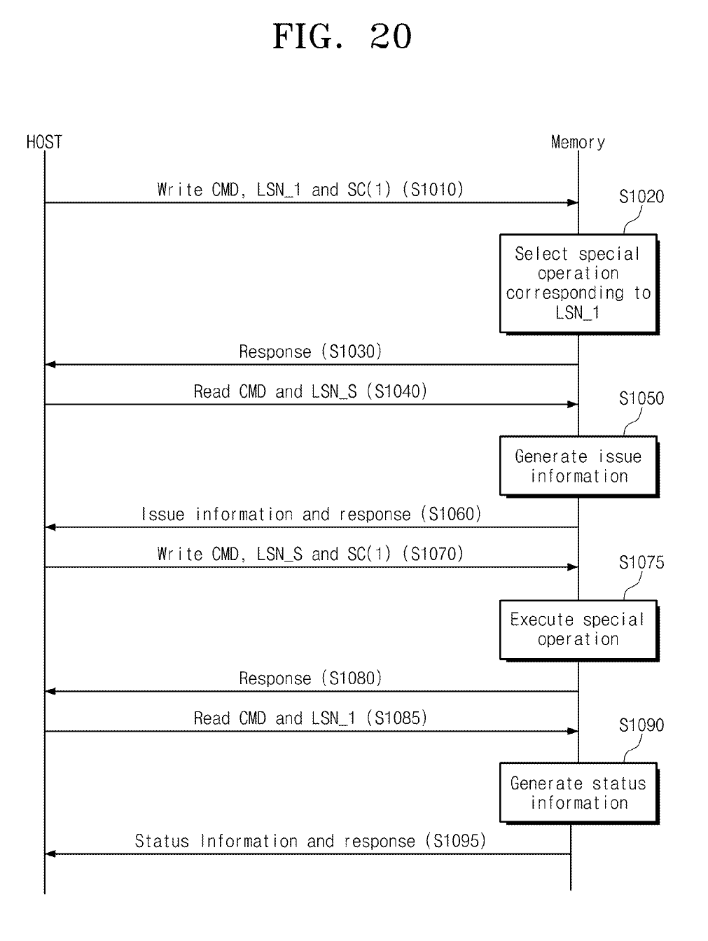

FIG. 20 is a flow chart schematically illustrating an example in which a special operation is issued. It is assumed that authentication described with reference to FIGS. 8 to 12 is passed.

Referring to FIGS. 1 to 3 and 18 to 20, in step S1010, the host provides the memory 160/170 with a write command, a first logical sector number LSN_1 of the dummy file DF, and a sector count SC of “1” in step S1010. That is, the host requests issuance of a special operation corresponding to the scan and read reclaim operation at the memory 160/170.

In step S1020, the memory 160/170 selects a special operation corresponding to the first logical sector number LSN_1 of the dummy file DF. For example, the scan and read reclaim operation is selected in the depicted example. In step S1030, the memory 160/170 sends a response to the host.

In step S1040, the host provides the memory 160/170 with a read command and a start logical sector number LSN_S of the dummy file DF. That is, the host requests confirmation of the special operation at the memory 160/170. In step S1050, the memory 160/170 generates issue information. For example, the issue information includes information about the special operation selected in step S1020. In step S1060, the memory 160/170 sends the issue information and a response to the host.

When the issue information received from the memory 160/170 corresponds to the special operation selected by the host, in step S1070, the host provides the memory 160/170 with a write command, a start logical sector number LSN_S of the dummy file DF, and a sector count of “1”. That is, the host requests execution of the special operation at the memory 160/170. When the issue information received from the memory 160/170 does not correspond to the special operation selected by the host, the method returns to step S1010. In step S1075, the memory 160/170 performs the special operation. For example, the memory 160/170 executes the special operation selected in step S1020. In step S1080, the memory 160/170 sends a response to the host.

In step S1085, the host provides the memory 160/170 with a read command and a first logical sector number LSN_1 of the dummy file DF. That is, the host requests status check at the memory 160/170. In step S1090, the memory 160/170 generates status information. For example, the memory 160/170 generates information indicating whether the special operation executed in step S1060 is completed and information about a result of the special operation. In step S1095, the memory 160/170 sends the status information and a response to the host.

As described above, the host issues a special operation to the memory 160/170 using a normal command and an address. Afterwards, the host confirms the issued special operation using a normal command and an address. When the confirmation is passed, the host directs execution of the issued special operation using a normal command and an address. Afterwards, the host checks an execution state of the special operation using a normal command and an address. By checking the execution state, the host determines whether the issued special operation is completed or whether the memory 160/170 is ready to perform another normal operation or special operation.

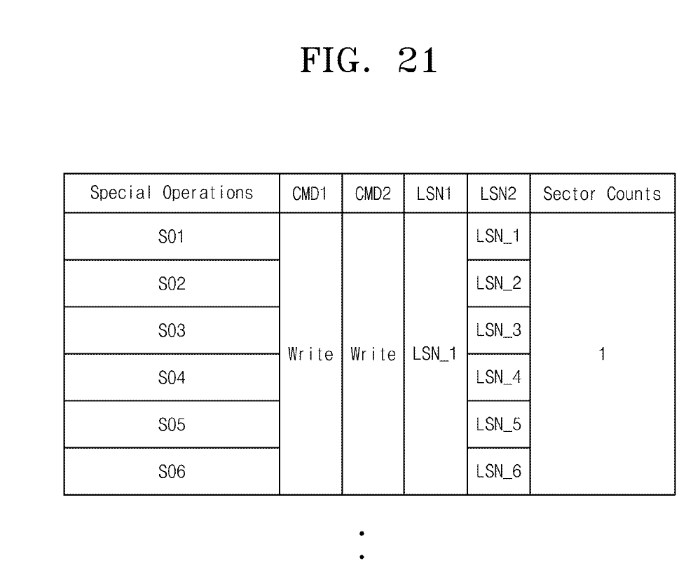

FIG. 21 is a table showing commands and addresses allocated to special operations, according to another embodiment of the inventive concept. Referring to FIGS. 1 to 3 and 21, two commands CMD1 and CMD2 are allocated to each of special operations SO1 to SO6. The first command CMD1 is a write command, and the second command CMD2 is a write command. The first command CMD1 is issued together with a first logical sector number LSN1. The second command CMD2 is issued together with a second logical sector number LSN2. The special operations SO1 to SO6 are selected by first and second logical sector numbers LSN1 and LSN2. That is, the special operations SO1 to SO6 are selected by a combination of two bits corresponding to the first and second logical sector numbers LSN1 and LSN2, respectively. In this case, more special operations may be issued to the memory 160/170 by the host.

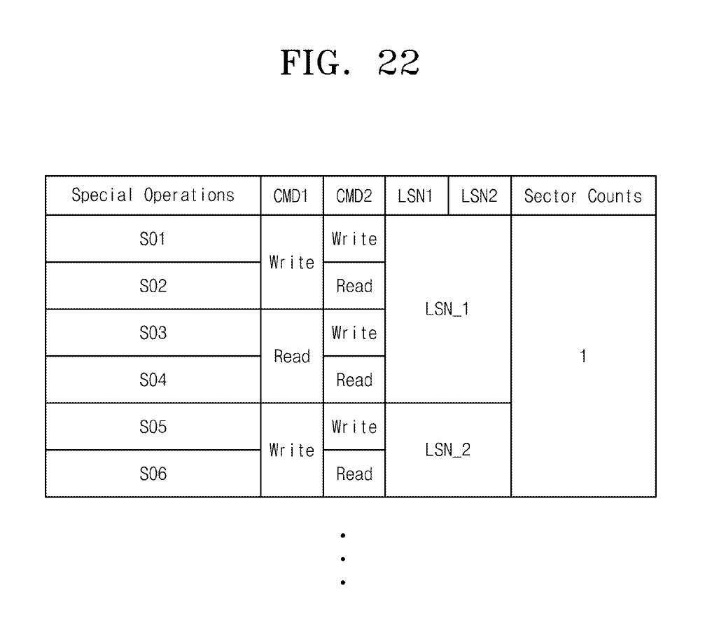

FIG. 22 is a table showing commands and addresses allocated to special operations, according to still another embodiment of the inventive concept. Referring to FIGS. 1 to 3 and 22, two commands CMD1 and CMD2 are allocated to each of special operations SO1 to SO6. In the special operations SO1, SO2, SO5, and SO6, the first command CMD1 is a write command, and in the special operations SO3 and SO4, the first command CMD1 is a read command. In the special operations SO1, SO3, and SO5, the second command CMD2 is a write command. In the special operations SO2, SO4, and SO6, the second command CMD2 is a read command. In the special operations SO1 to SO4, first and second logical sector numbers LSN1 and LSN2 are a first logical sector number LSN_1. In the special operations SO5 and SO6, the first and second logical sector numbers LSN1 and LSN2 are a second logical sector number LSN_2. In the special operations SO1 to SO6, a sector count is “1”.

That is, the special operations SO1 to SO6 are selected by first and second commands CMD1 and CMD2 and first and second logical sector numbers LSN1 and LSN2 that are used in common for the first and second commands CMD1 and CMD2. The first command CMD1 forms a bit, the second command CMD2 forms another bit, and the first and second logical sector numbers LSN1 and LSN2 form the another bit. That is, the special operations SO1 to SO6 are selected by a combination of three bits.

As described with reference to FIG. 21, the first and second logical sector numbers LSN1 and LSN2 also have different values to select the special operations SO1 to SO6. In particular, the special operations SO1 to SO6 are selected by a combination of four bits: a first bit corresponds to a first command CMD1, a second bit corresponds to a second command CMD2, a third bit corresponds to a first logical sector number LSN1, and a fourth bit corresponds to a second logical sector number LSN2.

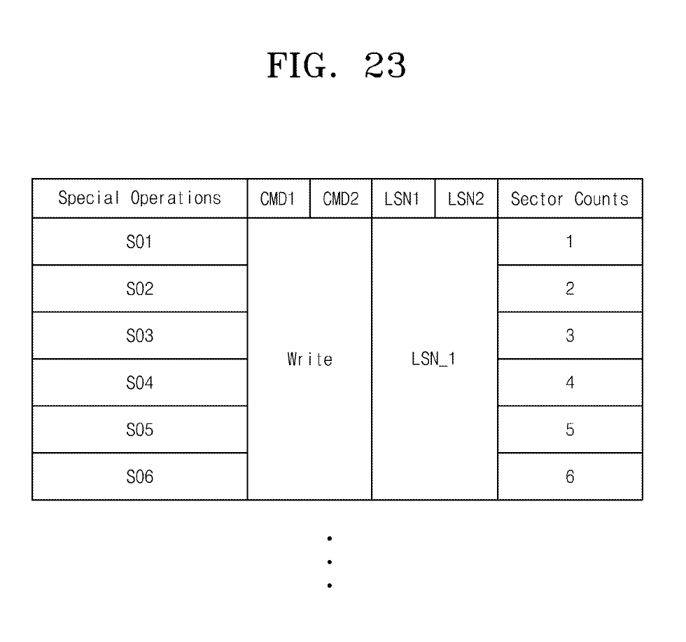

FIG. 23 is a table showing commands and addresses allocated to special operations, according to a further embodiment of the inventive concept. Referring to FIGS. 1 to 3 and 23, two commands CMD1 and CMD2 and two logical sector numbers LSN1 and LSN2 are allocated to each of special operations SO1 to SO6. The special operations SO1 to SO6 are selected according to a sector count SC.

In the event that the embodiment of FIG. 22 and the embodiment of FIG. 23 are combined, the special operations SO1 to SO6 are selected by a combination of five bits: first and second bits correspond to first and second commands CMD1 and CMD2, third and fourth bits correspond to first and second logical sector numbers LSN1 and LSN2, and a fifth bit corresponds to a sector count SC.

Methods of selecting special operations described with reference to FIGS. 19 and 21 to 23 are applicable to operations for issuing special operations described with reference to FIG. 18.

A method of selecting the special operations SO1 to SO6 is selected in the memory 160/170. In step S560 of FIG. 12, for example, a method of selecting the special operations SO1 to SO6 is loaded on the host as special operation information. For example, the host previously stores methods of selecting special operations of various memories. The host acquires an identifier of the memory 160/170 and selects one of the methods of selecting special operations of various memories as a method of selecting special operations of the memory 160/170, using the acquired identifier.

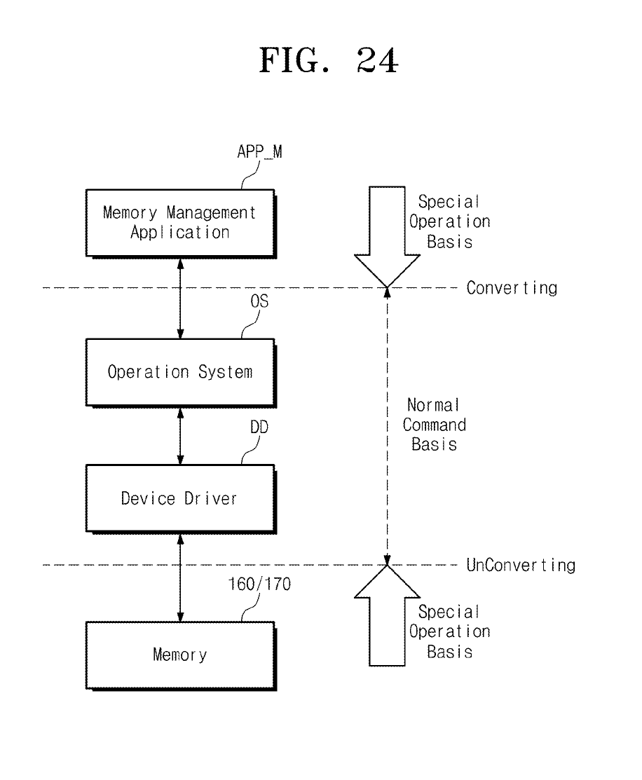

FIG. 24 is a block diagram schematically illustrating a software hierarchy according to an embodiment of the inventive concept. Referring to FIG. 24, a memory management application APP_M is driven by an operating system OS. The memory management application APP_M includes management software that optimizes operational performance of the memory 160/170 and improves reliability of the memory 160/170. The memory management application APP_M provides a variety of memory management tools using a variety of special operations supported by the memory 160/170. For example, the memory management application APP_M may be based on a special operation.

In the event that execution of a special operation of the memory 160/170 is required, the memory management application APP_M converts a request for the special operation into a normal command and an address corresponding to a rule, e.g., shown in FIG. 5, based on methods described with reference to FIGS. 5 to 23.

The operating system OS does not grant root authority to the memory management application APP_M. Although the operating system OS grants root authority to the memory management application APP_M, the memory 160/170 is connected via a reader 180 (refer to FIG. 3). That is, the operating system OS and a device driver DD operate based on a normal command.

A request for the special operation is converted into a normal command and an address for transmission. Thus, although the operating system OS does not grant root authority to the memory management application APP_M and although the memory 160/170 is connected via the reader 180, a request for the special operation generated by the memory management application APP_M is transferred to the memory 160/170 using a normal command and an address.

The memory 160/170 extracts the request for the special operation from the normal command and address. The memory 160/170 performs the special operation according to the request for the special operation thus extracted. That is, the memory 160/170 operates based on the special operation.

With embodiments of the inventive concept, although a layer supporting only normal commands exists between the memory management application APP_M and the memory 160/170, the memory management application APP_M is able to issue the special operation to the memory 160/170. Thus, a command issuing method and a command processing method are provided to improve operation performance.

In the above embodiments, an example is provided in which the operating system OS drives a master boot record MBR, FAT1, and FAT2. That is, the operating system OS is based on FAT. However, embodiments of the inventive concept are not limited to the operating system OS being based on FAT. Various modifications and changes to on the operating system OS may be made, without departing from the scope of the present teachings.

In the above embodiments, an example is provided in which a special operation is issued according to a write command. However, embodiments of the inventive concept are not limited thereto.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

1. A method of enabling performance of special operations by an application specific to a memory device, the method comprising:
performing at least one of a first authentication operation and a second authentication operation of the memory device using at least one normal command received from the application according to at least one predefined rule, respectively, the first and second authentication operations indicating whether the memory device includes a plurality of special operations; and
receiving from the application a first normal command with a starting logical sector number of a dummy file and a second normal command with a last logical sector number of the dummy file, enabling determination of whether the at least one of the first authentication operation and the second authentication operation of the memory device is successful.

2. The method of claim 1, further comprising:
when the at least one of the first authentication operation and the second authentication operation is determined to be successful, sending signature data and special operation information corresponding to the special operations to the application.

3. The method of claim 2, wherein the special operation information is sent to the application when the signature data corresponds to a predefined signature data pattern.

4. The method of claim 2, wherein the special operation information enables performance of a special operation from among the plurality of special operations using a normal command and an address corresponding to the at least one normal command.

5. The method of claim 2, wherein the signature data and special operation information corresponding to the special operations are sent only when both the first authentication operation and the second authentication operation are performed and determined to be successful.

6. The method of claim 2, wherein the signature data is sent in response to the first normal command with the starting logical sector number received from the application.

7. The method of claim 6, wherein the special operation information is sent in response to the second normal command with the ending logical sector number received from the application.

8. The method of claim 1, wherein the at least one normal command comprises at least one of a write command and a read command.

9. The method of claim 1, wherein performing the first authentication operation comprises:
sequentially receiving write commands, a logical sector number of the dummy file with predefined sector counts corresponding to the write commands, and dummy data for executing write operations; and
passing the first authentication operation when the predefined sector counts have a pattern according to a first predefined rule.

10. The method of claim 1, wherein performing the second authentication operation comprises:
sequentially receiving a plurality of read commands and any logical sectors with corresponding predefined sector counts for executing read operations; and
passing the second authentication operation when the predefined sector counts have a pattern according to a second predefined rule.

11. The method of claim 1, wherein the special operations comprise at least two of a scan and read reclaim operation, a merge operation, a vender authentication operation, a firmware update operation, a disk information operation and an all block erase operation.

12. A memory device, comprising:
a host interface for interfacing communications with a host device running an application;
a nonvolatile memory storing a plurality of special operations executable by the application; and
a controller for accessing the nonvolatile memory in response to normal commands received from the application through the host interface,
wherein the controller is configured to:
perform an authentication operation using a normal command and corresponding address received from the application through the host interface according a predefined rule, the authentication operation indicating whether the nonvolatile memory includes the plurality of special operations; and
receive a first normal command with a starting logical sector number of a dummy file and a second normal command with a last logical sector number of the dummy file, enabling determination of whether the authentication operation is successful.

13. The memory device of claim 12, wherein the controller is further configured to generate signature data in response to the first normal command when the authentication operation is determined to be successful, the signature data having been previously stored in the nonvolatile memory, and to provide the signature data to the application through the host interface.

14. The memory device of claim 13, wherein the controller is further configured to generate special operation information corresponding to the special operations included in the nonvolatile memory in response to the second normal command when the authentication operation is determined to be successful, and to provide the special operation information to the application through the host interface.

15. The memory device of claim 14, wherein the controller is further configured to control execution of a special operation from among the plurality of special operations in response to a normal command and an address received from application through the host interface, based on the special operation information provided to the application.

16. The memory device claim 12, wherein the nonvolatile memory comprises one of a flash memory, FRAM, PRAM, MRAM, RRAM, or EEPROM.

17. A method of performing special operations specific to a memory device, the method comprising:
initiating at least one of a first authentication operation and a second authentication operation of the memory device by issuing to the memory device at least one normal command device according to at least one predefined rule, respectively, the first and second authentication operations indicating whether the memory device includes a plurality of special operations;
issuing to the memory device a first normal command with a starting logical sector number of a dummy file in the memory device and a second normal command with a last logical sector number of the dummy file; and
determining whether the at least one of the first authentication operation and the second authentication operation of the memory device is successful based on responses by the memory device to the first and second normal commands, respectively.

18. The method of claim 17, further comprising:
when the at least one of the first authentication operation and the second authentication operation is determined to be successful, receiving signature data and special operation information corresponding to the special operations from the memory device.

19. The method of claim 18, further comprising:
selecting a special operation from among the plurality of special operations in the received special operation information;
selecting a normal command and an address, comprising a logical sector number and a sector count in the dummy file, allocated to the selected special operation; and
issuing the selected special operation by sending the selected normal command and the address to the memory device for performing the special operation.

20. The method of claim 17, wherein the signature data and special operation information corresponding to the special operations are received only when both the first authentication operation and the second authentication operation are determined to be successful.

21. The method of claim 17, wherein the signature data is received following execution of the first normal command by the memory device, and
wherein the special operation information is received following execution of the second normal command by the memory device.

22. The method of claim 17, wherein performing the first authentication operation comprises:
sequentially sending write commands, a logical sector number of the dummy file with predefined sector counts corresponding to the write commands, and dummy data for executing write operations, wherein the first authentication operation passes when the predefined sector counts have a pattern according to a first predefined rule.

23. The method of claim 17, wherein performing the second authentication operation comprises:
sequentially sending a plurality of read commands and any logical sectors with corresponding predefined sector counts for executing read operations, wherein the second authentication operation passes when the predefined sector counts have a pattern according to a second predefined rule.
